(19) United States
(12) Patent Application Publication
(10) Pub. No.: US 2019/0163922 A1
(43) Pub. Date: May 30, 2019

(54) DELIVERY OF ELECTRONIC DOCUMENTS TO REMOTE DEVICES

(71) Applicant: MINDLOGICX SINGAPORE PTE LIMITED, Singapore (SG)

(72) Inventor: Suresh Elangovan, Bangalore (IN)

(21) Appl. No.: 16/198,903

(22) Filed: Nov. 23, 2018

(30) Foreign Application Priority Data
Nov. 28, 2017 (IN) 201741042685

(51) Int. Cl. G06F 21/60; H04L 29/06; H04L 9/08; H04L 12/58

(52) U.S. Cl. CPC G06F 21/606; H04L 63/0876; G06F 21/602; H04L 51/12; H04L 63/0861; H04L 51/38; H04L 9/0861

(57) ABSTRACT

Methods and system to deliver electronic documents are hereby disclosed. A delivery system operating with an administration system for delivering electronic documents comprising a plurality of remote devices, each for use by a corresponding intended recipient; a local server to receive an electronic document from the administration system on a secure channel ahead of a required delivery time and a local hub to receive the electronic document from the local server ahead of the required delivery time. The plurality of remote devices interfaces with the local hub to authenticate a corresponding intended recipient and to receive the electronic document upon successful authentication, wherein the local server, the local hub and each remote device operate in conjunction to ensure that the content of the electronic document is available to the corresponding recipient only at the required delivery time.

### PRIORITY CLAIM

The instant patent application is related to and claims priority from the co-pending India provisional patent application entitled, “DELIVERY OF ELECTRONIC DOCUMENTS TO REMOTE DEVICES IN A SECURED, RESTRICTED AND SCHEDULED MANNER”, Serial No.: 201741042685, Filed: Nov. 28, 2017, which is incorporated in its entirety herewith to the extent not inconsistent with the disclosure herein.

### BACKGROUND OF THE DISCLOSURE

### Technical Field

The present disclosure relates to document delivery systems and more specifically to delivery of electronic documents to remote devices in a secured, restricted and scheduled manner.

### Related Art

An electronic document, as used in the present application, refers to a digital representation of content normally written on paper for use by target group of people. As may be readily appreciated such electronic documents are typically managed as respective files and each file is thereafter transmitted to the individuals of the target group. Thus, instead of receiving a paper correspondence, a recipient can work with the electronic document thereafter.

Devices are often used to receive such electronic documents. The devices can be specialized devices or more general-purpose devices such as mobile phones, tablets, laptops and portable devices as such, as suited for the corresponding purpose. The devices are hereafter generally referred to as ‘remote devices’ merely to indicate that the intended recipients of electronic documents are typically at farther distance from the source location from which the document is sought to be transmitted.

There is often a need to deliver electronic documents to remote devices according to the requirements of the corresponding environment. For example, when administering examinations in remote locations, it may be required to deliver the electronic documents in a secured, restricted and scheduled manner. The term secured means that the content should ideally not be decipherable by unknown third parties in the transmission path. The term restricted means that only the target recipient should be able to view the corresponding electronic document. The term scheduled means that the document should ideally be available only within a window, e.g., after a specific time point.

As may be readily appreciated the examinees can be located remotely from an authority administering the examination and accordingly the authority may wish to deliver electronic documents to devices of such examinees in a secured, restricted and scheduled manner.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a block diagram of a delivery system according to several aspects of the present disclosure.

FIGS. 3A and 3B together depict a flow chart illustrating the manner in which electronic documents are delivered to remote devices in a secured, restricted and scheduled manner according to an aspect of the present disclosure.

FIG. 4 depicts various portions of data maintained by a delivery system in one embodiment.

FIG. 5A is a block diagram of another embodiment of a delivery system according to several aspects of the present disclosure,

FIG. 5B is a block diagram of a server-hub copier according to an aspect of the present disclosure.

FIG. 5C is a block diagram of a hub-device carrier according to an aspect of the present disclosure.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

According to an aspect of the present disclosure, a delivery system operable in conjunction with an administration system delivers electronic documents. The delivery system includes multiple remote devices, each for use by a corresponding intended recipient; a local server to receive an electronic document from the administration system on a secure channel ahead of a required delivery time; and a local hub to receive the electronic document from the local server ahead of the required delivery time. The remote devices interface with the local hub to authenticate a corresponding intended recipient and to receive the electronic document upon successful authentication. The local server, the local hub and each remote device operate in conjunction to ensure that the content of the electronic document is available to the corresponding recipient only at the required delivery time.

According to another aspect of the present disclosure, the administration system performs encryption of the electronic document to generate an encrypted document, with the local server and local hub receiving and forwarding the encrypted document to the multiple remote devices. Each remote device performs decryption of the encrypted document just prior to the required delivery time to facilitate the content of the electronic document to be made available to the corresponding recipient. In one embodiment, the encryption and decryption is performed using a 128-bit key.

Thus, aspects of the present disclosure provide “Just in Time” secure delivery of encrypted electronic documents to the right device, right location and at the right time with the required security measures (including but not limited to geo-location, biometrics, hardware authentication, time-based authentication and password). Only the remote devices may decrypt the electronic document for displaying to the right user/intended recipient.

According to one more aspect of the present disclosure, the local server also receives from the administration system, a session data indicating the required delivery time of the electronic document and the authentication details of the intended recipients, with the local hub receiving the session data from the local server and performing authentication of the corresponding intended recipients based on the session data.

According to yet another aspect of the present disclosure, the local hub authenticates the specific remote device (e.g., based on a unique identifier allocated to each remote device according to a pre-specified convention), in addition to the user authentication of the intended recipient. In one embodiment, the user authentication is performed using a combination of multiple parameters including user data validation, time-based validation and user biometrics including one or more of finger-prints, retina scan and face scan.

According to an aspect of the present disclosure, the local server receives the electronic document and the session data over a secured communication channel, stores a local copy of the electronic document and the session data in a secured storage and provides the local copy of the electronic document and the session data to the local hub. Accordingly, the combination of the local server, local hub and the multiple remote devices forms a “mini-cloud” that can be isolated from the administration system after receipt of the electronic document and the session data on the network.

According to another aspect of the present disclosure, the delivery system includes a server-hub copier that copies the electronic document and the session data from the local server to the local hub via a physical interface (in one embodiment, implemented using RS-232 protocol). By using such a physical interface, the possibility of snooping by unknown third parties is reduced, thus facilitating the electronic document to be delivered in a more secured manner.

According to one more aspect of the present disclosure, the local hub generates credentials for establishing a local network, transmits the generated credentials to the one or more remote devices through a short distance wireless protocol such as Near Field Communication (NFC) or Bluetooth protocol. According to an aspect, the local hub allows only a pre-configured set of remote devices to connect and receive the credentials through the short distance protocol. In one embodiment, the configuration is based on the hardware tags contained in the remote devices.

Accordingly, a remote device establishes a connection over the local network with the local hub using the network credentials and receives the electronic document and the session data over the connection upon successful authentication. By using short distance protocols, the possibility of hacking by unknown third parties are again reduced. By using wireless protocol, the convenience of quick transfers without physical interfaces is obtained.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

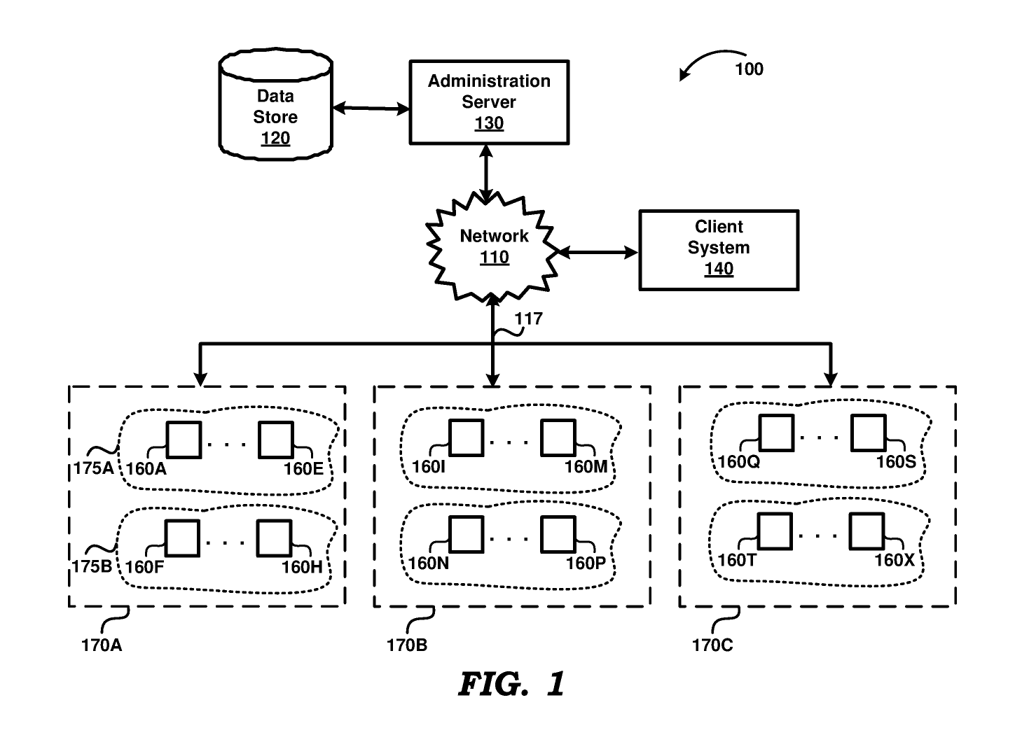

FIG. 1 is a block diagram illustrating an example environment (computing system 100) in which several aspects of the present disclosure can be implemented. The block diagram is shown containing network 110, data store 120, administration server 130, client system 140 and remote devices 160A-160X. Merely for illustration, only representative number/type of systems is shown in the FIG. 1. Many environments often contain many more systems, both in number and type, depending on the purpose for which the environment is designed. Each system/device of FIG. 1 is described below in further detail.

Broadly, an examination authority uses administration server 130, data store 120 and client system 140 to provide examination question papers in the form of electronic documents. The electronic documents are transmitted to remote devices for the examinees to answer the questions in the question paper.

For illustration, computing system 100 is shown containing three examination centers 170A, 170B and 170C (for testing the examinees) along with Data store 120, Administration Server 130, Client System 140 and Network 110. Examination center 170A is shown containing portable devices 160A-160E, Examination center 170B is shown containing portable devices 1601-160P and examination center 170C is shown containing portable devices 160Q-160X.

Client system 140 uploads the electronic document along with examination data (data pertaining schedule of the examination, the intended examinees and the details of the examination centers) to the Administration server 130 through the Network 110 under the direction of an administrator. Administration server 130 encrypts and stores the electronic data and the examination data in the data store 120.

Administration server 130 represents a server, such as a web/application server, executing applications/software modules enabling conduct of examination in geographically diverse locations. Administration server 130 also comprises an integrated examination management system that incorporates and enables the conduct of the examinations in multiple geo locations located in different geographical areas. The administration server 130 uses the data store 120 for storage and retrieving data required for conducting the examinations. The entire process of electronic document generation and publication on remote devices can be tracked using Administration server 130 using relevant software modules.

Data store 120 represents a non-volatile (persistent) storage facilitating storage and retrieval of data (examinee data, examination schedule, time of the examination, specific subject details, examination center data etc.) by applications executing in administration server 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts. Typically, the data associated with conduct of examination is stored as a combination of both relational/non-relational databases and file systems.

Client system 140 represents a system such as a personal computer, workstation, mobile device, computing tablet etc., used by examination conducting authority to upload the data pertaining to schedule of exams, examinees, examination centers, examinee authentication data (biometric data) to administration server 130 directed to conduct of examinations. In one aspect of the invention, the entire process of question paper generation and publication on hand-held devices by the client system 140 is tracked using dashboards based graphical display.

Each of remote devices 160A-160X represents a system such as a personal computer, workstation, mobile station, mobile phones, computing tablets, etc., which can be used by the users (e.g. examinees) for receiving the encrypted electronic document at a scheduled period of time. In a given examination center 170A, the remote devices are grouped into sets of devices (175A and 175B).

As noted in the Background section, it may be required that the electronic documents be delivered from the examination authority to the remoted devices in a secure, restricted and scheduled manner. The manner in which such delivery of the electronic documents to remote devices may be provided is described below with examples.

### 3. Illustrative Example

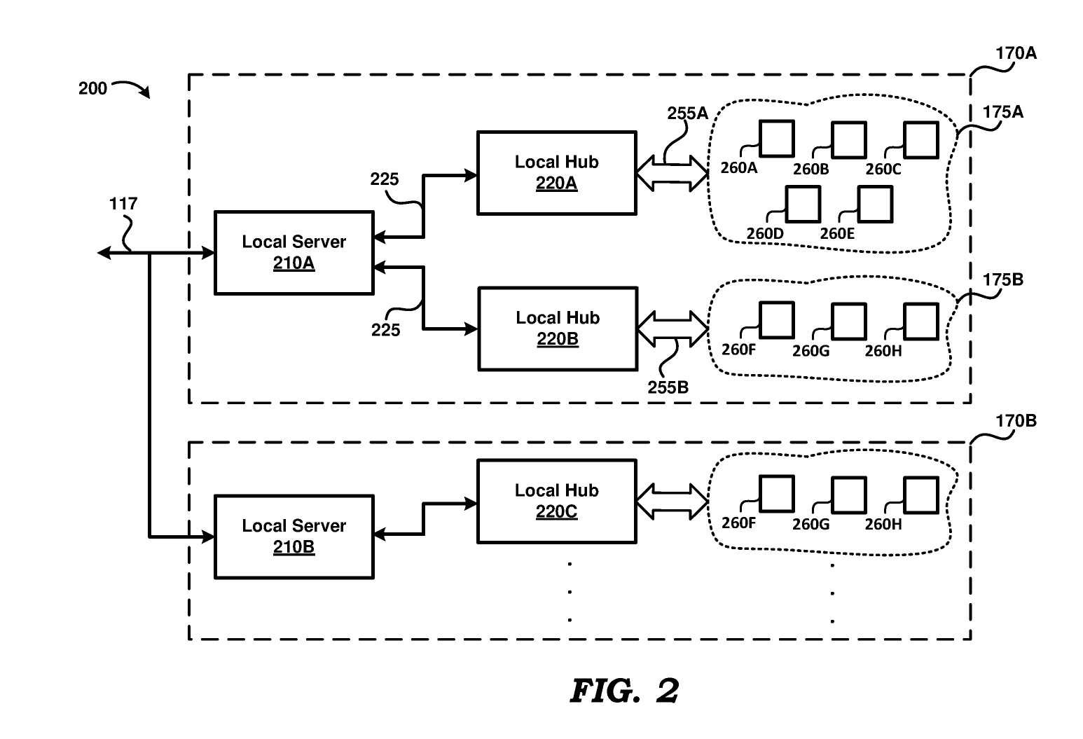

FIG. 2 is a block diagram illustrating the details of delivery system 200 according to an aspect of the present disclosure. The block diagram is shown containing Local server 210A, Local Hub 220A, Local Hub 220B, groups of the remote devices 175A, 175B present in geolocation 170 A and Local Server 220B, Local Hub 220C along with a group of remote devices 260F-260H present in geolocation 170B. In another embodiment, the administration server 130 and the data store 120 are a part of the delivery system 200 (though not shown in the diagram).

Merely for illustration, only representative number/type of systems/delivery systems are shown in the Figure. Many environments often contain many more geolocations (examination centers), each in turn containing many more systems, both in number and type, and located geographically separately (but connected to the administration system 140 corresponding network paths such as 117 through the network 110 of FIG. 1) depending on the purpose for which the environment is designed. Each system/device of FIG. 2 is described below in further detail.

According to an aspect of the present disclosure, local servers 210A,210 B are servers that are located at examination centers 170A and 170B. Each of local servers 210A and 210B operates and coordinates the delivery of the encrypted electronic document at the examination center. Local servers 210A and 210B are configured to operate only from the specific examination center and are geographically tagged to the specific examination center by providing the geographical coordinates of the examination center. Administration server 130 performs authentication of local server 210 based on geo-location data (e.g. stored GPS coordinates of local servers 210A/210B and/or the specific physical IDs (such as MAC ID, CPU ID) of local servers 210A/210B tagged to the specific geo-locations). After authenticating, local servers 210A and 210B, administration server 130 then synchronizes the time with local servers 210A and 210B and then initiates the transfer of the encrypted electronic document along with the data required for the conduct of the examination (examinee data, examination schedule, time of the examination, specific subject details, examination center data etc.).

Each of local servers 210A and 210B has synchronized itself with administration server 130 and is ready to operate as a standalone device for delivery of the secured electronic document in a given examination center. In one embodiment, local servers 210A and 210B do not contain additional ports to connect additional devices (standard storage devices and input/output devices) and thereby local servers 210A and 210B are secured and cannot be hacked or accessed by third parties.

By restricting and mapping each of local servers 210A and 210B in specific geolocations to specific restricted areas, each of the examination centers are geo-fenced and enables rogue devices that are outside the geo-location to be identified and monitored for malpractices during examinations.

A given examination center has to conduct examination for multiple examinees and accordingly, an examination center in a given geolocation has multiple examination halls wherein the examinees appear for the scheduled examination.

According to an aspect of the present disclosure, local hubs 220A,220B and 220C are used to deliver the encrypted electronic document to remote devices distributed among multiple halls inside the specified examination center. For the sake of convenience, the operation of local hub 220A is explained herewith. The operations of the local hubs 220B and 220C are similar to that of 220A.

Local hub 220A is a hardware device having both short distance and longer distance wireless protocols, both for communicating with the remote devices. For example, for short distance wiles, a Near Field Communication (NFC) transmitter and/or a blue tooth transmitter may be provided. For longer distance communication, local hub 220A may be provided with WIFI capability.

According to an aspect of the present invention, local server 210A transfers data to the local hubs 220A and 220B via path 225 in a given examination center 170A. On completion of the copying of the data between local server 210A and the local hub 220A and local hub 220B, are ready to operate in conjunction with a set of remote devices to deliver the encrypted electronic document at the scheduled time.

Each of the examinees in a specified examination hall is provided with remote devices where the encrypted electronic document is displayed at the scheduled time. According to an aspect of the present disclosure, remote devices 260A-260H can be specialized devices or more general-purpose devices such as mobile phones, tablets, laptops and portable devices as such, as suited for the corresponding purpose. The remote devices could be specialized devices that can mimic the appearance of the ordinary ink on paper.

According to an aspect of the invention, the set of remote devices 260A-260E (shown as group 175A) are paired to work with local hub 220A and remote devices 260F-260H are paired to work with local hub 220B in the examination center 170A. According to an aspect of the present disclosure, the local hubs and the remote devices are tightly coupled with each other based on hardware tags. Specialized hardware such as Near Field Communication tags are used to couple a specific local hub to a corresponding group of remote devices.

The interaction between the remote devices 260A-260E with local hub 220A happens through network path 255A and remote devices 260F-260H with local hub 220B through network path 255B. The network paths 255A and 255B are wireless in nature and are a combination of short-range wireless communication such as Bluetooth, Wireless local area networking protocols such as Wi-fi and Near Field Communication.

According to an aspect of the invention, a local hub is configured to work with multiple remote devices by using specific network credentials generated for delivery of encrypted electronic document for a specific session and period of time. The remote devices 260A-260E connects to local hub 220A by using the specific network credential. On connecting with the local hub, the time of the remote device is synchronized with the local hub's time, which is synchronized to the local server's time, which is already synchronized to administration server 130's time.

At the scheduled time of the examination, each of the remote devices 260-260E receives the encrypted electronic document with the key. Accordingly, the delivery system 200 ensures “Just In Time” secured delivery of encrypted electronic documents to the intended recipient having the remote device, ensuring delivery of the secured document at the right location and at the scheduled time along with a secured and restricted delivery including security features such as geolocation, biometrics, hardware authentication, time based authentication and password. The intended recipient is displayed the document only after he/she provides his biometric authentication before the display of the electronic document.

Thus, local server 210 and local hubs 220A-220B for a given examination center 170A for a given sub-group 175A downloads, transfer and then transmits the encrypted electronic document together operate to provide secured delivery of the encrypted electronic document from administration server 130 to remote devices 260A-260X of FIG. 2. The manner in which the encrypted electronic document is provided to the intended recipient is explained below.

### 4. Providing Encrypted Electronic Document to Intended Recipient

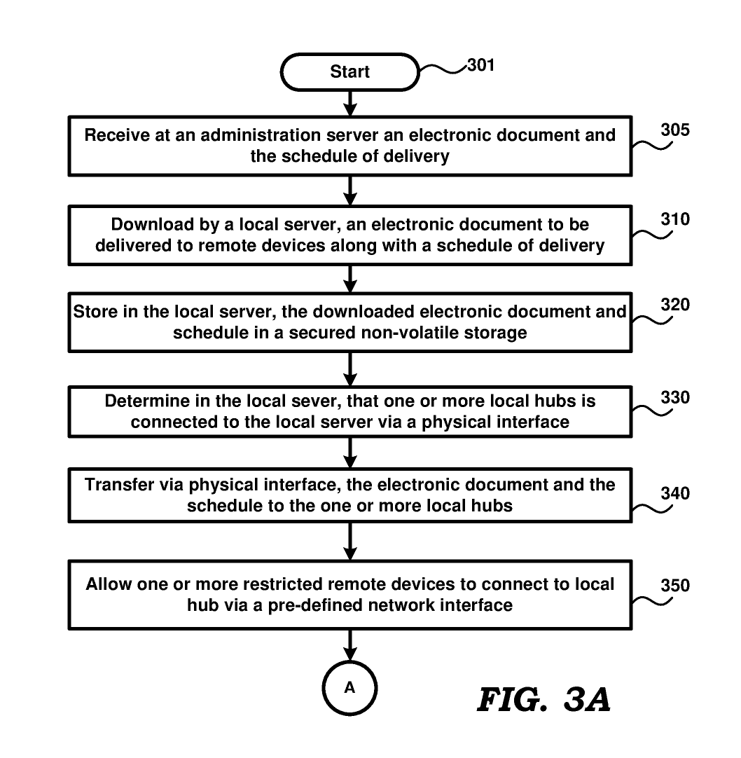

FIGS. 3A and 3B together depict a flow chart illustrating the manner in which the delivery of electronic documents to remote devices in a secured, restricted and scheduled manner is performed using the intermediate combination of devices of FIG. 2. The flowchart is described with respect to the systems of FIG. 2, merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 301, in which control immediately passes to step 305.

In step 305, an electronic document and the schedule of delivery is received at the administration server 130 and subsequently stored in the data store 120.

In step 310, the local servers (210A-210B) downloads the electronic document to be delivered to remote devices along with a schedule of delivery. Prior to initiating the download of the data, the Administration server 130 performs authentication of the Local server 210 based on geo-location data (e.g. stored GPS coordinates of the Local server 210 and/or the specific physical IDs (such as MAC ID, CPU ID) of the Local servers (210A-210B) tagged to the specific geo-location). The download of the electronic document and the schedule of delivery is initiated after the synchronization of time between the Administration server 130 and the Local servers 210A and 210B.

In step 320, the local servers 210A and 210B stores the downloaded electronic document and the schedule of delivery in a secured non-volatile storage device and disconnects from the Administration server 130. The electronic document may be received in encrypted format, and a corresponding decryption key may also be received. Such key may also be stored in the secured non-volatile storage. The Local server 210A is thereafter ready to operate as a stand-alone device and does not rely upon the administration server 130 for any data or actions to be performed (for reliable administration of the examinations thereafter).

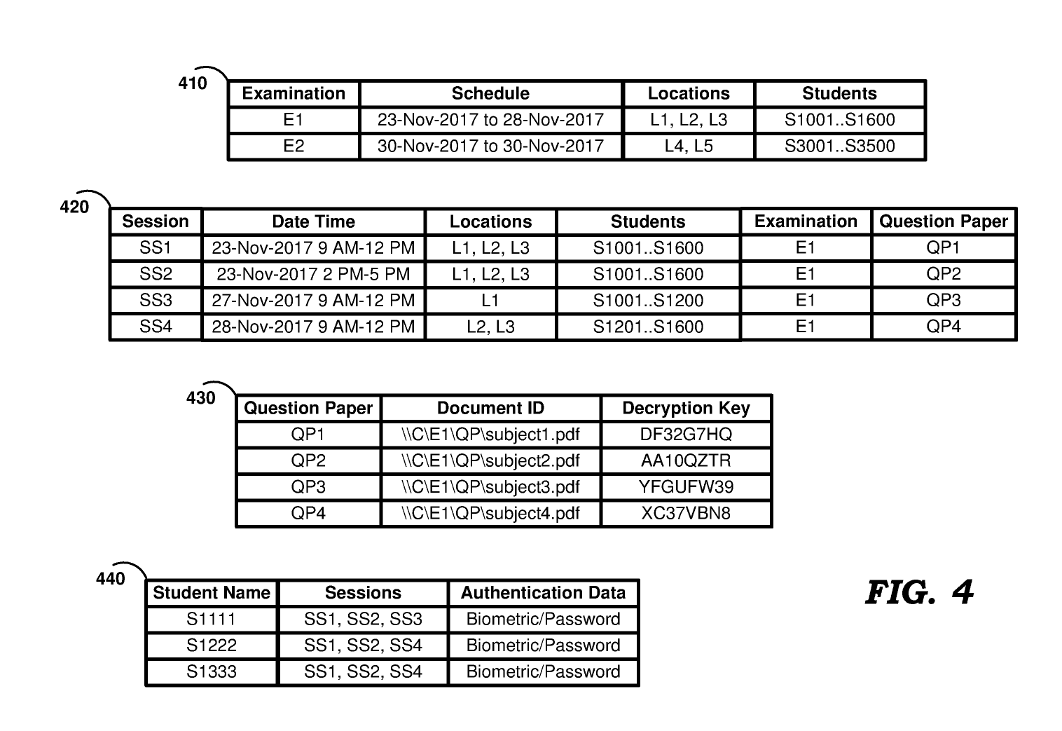

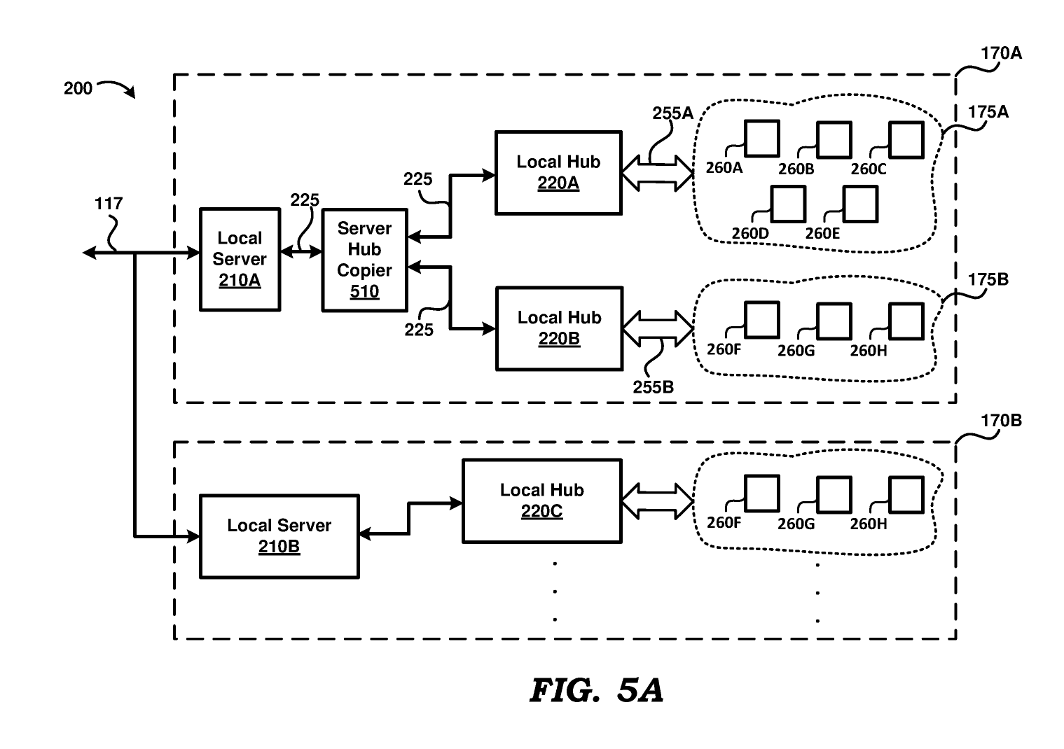

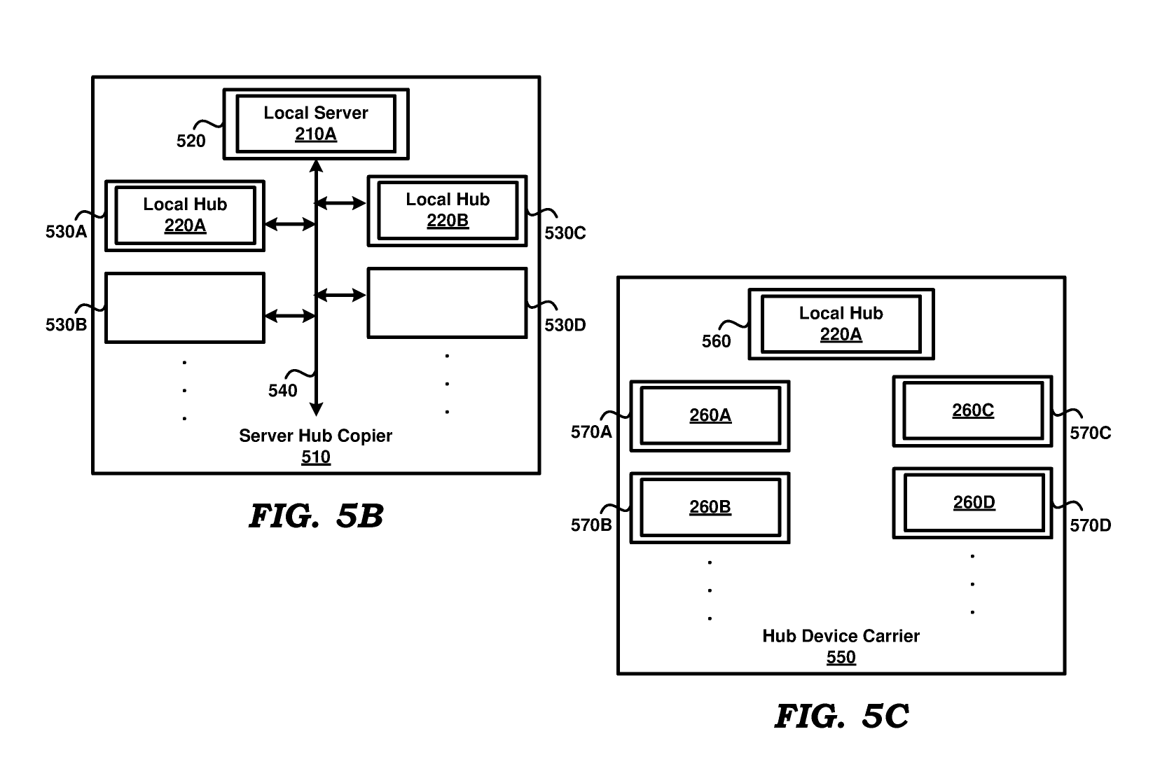

In step 330, each of the local servers 210A and 210B determines the corresponding setoff local hubs connected by respective physical interfaces. Here the physical interfaces means the path between the devices are physical in nature, contrasted to wireless media constituting the path. The physical interfacing of the devices and the transfer of the data between a local server and one or more local hubs could be performed using additional intermediate devices such as Server-Hub copier as shown in FIGS. 5A and 5B explained below.

Then, in step 340, the physical interface 225A-225B is used to transfer the electronic document and the schedule (along with decryption key) to one or more local hubs 220A-220B from the local server 210A.

In step 350, a local hub 220A is connected to a restricted remote devices 260A-260H through a short-range wireless connection. The local hub 220A allows one or more local devices 260A-260H to connect through a pre-determined network interface for the transfer of credentials. Such pre-determined network interface is a short-range wireless data exchange interfaces having range less than 10 meters such as Bluetooth or a Near Field Communication (NFC) between the remote device with the local hub.

The flowchart then moves on to step 360 shown in FIG. 3B, the one or more local devices 260A-260H receives network credentials from the local hub 220A for establishing a wireless local network connection (longer range wireless connection) with Local hub 220A through the short-range wireless connection. An example for such network credentials could be a combination of username/password; SSID and passkey etc. In one embodiment, the Local Hub 220A sends the network credentials to connect to the restricted set of remote devices through Near Field Communication (NFC).

In step 370, the local hub 220A receives a connection request from a remote device containing the credentials. The local hub 220A may accept the connection request by examining the credentials. The local hub 220A may examine unique identifiers such as MAC address also to determine whether the remote device should be permitted access. Accordingly, the list of permitted MAC addresses may also be received from the server system. A WiFi connection (longer range communication) may be established once the credentials and unique identifier of the remote system are found to match.

In step 380, the local hub transmits to the remote device, the encrypted electronic document, the decryption key and the schedule after a connection is established.

In step 390, the electronic document is decrypted using decryption key at the scheduled time and displayed on the remote device. The electronic document is displayed in the remote device only between the scheduled time and automatically stops displaying the electronic document after the scheduled time period.

In step 395, the one or more remote devices, send a blue tooth low energy “heartbeat” signal to the Local hub at regular intervals during the schedule, so as to indicate that the remote devices are in the range of the Local hub. On non-receipt of the “heartbeat” signal from the remote devices, appropriate action such as stopping the display of the secured document in the remote device, alarm to indicate movement of the device outside the designated area and automatically stop the display of the secured document is performed. The flowchart ends in step 399.

Thus, administration server 130 facilitates the local server 220A to deliver the electronic document to the remote devices in a secured manner by downloading the electronic document and the schedule of examination to the local server after authenticating the location and the credentials of the local server, then the electronic document and the schedule of examination are transferred from the local server to the local hubs using a physical interface thereby securing the electronic document and the schedule, the local hub transmitting the electronic document to the remote device by using secured credentials and restricting the devices that can connect to the local hub. By ensuring the examinee is handed a specific device, the electronic document is delivered only to the intended recipient.

The manner in which the delivery of electronic documents to remote devices in a secured, restricted and scheduled manner is explained further in the next section.

### 5. Providing Encrypted Electronic Document to Intended Recipient in a Secured and Restricted Manner

The manner in which the document is delivered to the intended recipient is described herein. The example is provided with respect to FIG. 2, with respect to the geolocation 170A. However, the features can be implemented in other systems and environments also without departing from the scope and spirit of various aspects of the present disclosure, as will be apparent to one skilled in the relevant arts by reading the disclosure provided herein.

The document to be securely delivered at a scheduled time is first uploaded to the cloud or the data store 120 by a designated set of authorized personnel (for e.g., personnel preparing question papers, the head of the certifying body) using the client system 140. The Authorized personnel is prompted to provide his credentials (Authentication using combination of multiple parameters including hardware authentication, user data validation, time-based validation and user biometrics including finger-prints, retina scan and face scan). The electronic document is uploaded along with the schedule to the Administration server 130 after encrypting the document and the schedule (see step 305 of the FIG. 3A).

Then, the Administration Server 130 stores the uploaded document and the schedule to the Data Store 120, in a non-volatile storage. The encrypted electronic document along with the schedule is accessible only to a designated set of authorized personnel (for e.g. personnel preparing question papers, the head of the certifying body). The encrypted electronic document and the schedule is ready for delivery to various geo-locations (examination centers) at the specified schedule of delivery.

At a given geo-location 170A, Local Server 210A is placed and connected to the Administration Server 130 through network 117. The Administration Server 130 then performs authentication of the Local Server 210A, based on geo-location data (e.g. stored GPS coordinates of the Local servers 210A,210B and/or the specific physical IDs (such as MAC ID, CPU ID) of the Local server 210A tagged to the specific geo-locations). The authorized personnel (such as a Controller of Examinations) for the specific geo-location for the conduct of examination, provides his credentials to the Administration Server 130 using a combination of multiple parameters including hardware authentication, user data validation, time-based validation and user biometrics including finger-prints, retina scan and face scan. Upon authentication of the authorized personnel, the Local Server 210A, synchronizes the time with the Administration Server 130, and then initiates the transfer of the encrypted electronic document along with the data required for conduct of the examination (examinee data, examination schedule, time of the examination, specific subject details, examination center data etc.) (Step 310 of FIG. 3A). The Local Server 210 then stores the encrypted electronic document and schedule in a secured non-volatile storage.

The Local server 210A has synchronized itself with the Administration server 130 and is ready to operate as a standalone device for delivery of the secured electronic document in a given examination center.

In order to conduct examinations for the multiple examinees, an examination center in a given geolocation has multiple examination halls wherein the examinees appear for the scheduled examination. Local Hubs (220A, 220B) are used to deliver the encrypted electronic document to remote devices. To conduct and co-ordinate the scheduled examinations, the Local server 210A is physically interfaced with one or more local hubs (220A, 220B) for copying the encrypted electronic document and the schedule. To perform the operation between a single server 210A and multiple local hubs in a given examination center, a Server-Hub copier may be used. The operations of the Server Hub copier is explained in Section 5 and as shown in FIGS. 5A and 5B. To initiate the copying of the data pertaining to conduct of examination and to copy the encrypted electronic document, the authorized personnel in charge of the examination center provides his credentials (username/password and biometric credentials) to initiate transfer of the schedule and the secured document to the local hubs 220A,220B. (See steps 330 and 340 of FIG. 3A). The Local Hubs 220A and 220B are placed in a specific mode of operation (i.e. Data copy mode) for facilitating the copying from the Local Server 210A.

On completion of the copying of data into each of the local hubs, the local hubs 220A, 220B are removed from the Server Hub copier. Before removing the local hub, the designated personnel (invigilators) in charge of conducting the examination in a given examination hall provides their credentials (username/password and biometric credentials) which are then authenticated and then allowed to carry the local hub along with the set of restricted remote devices to the respective examination halls.

The Local Hub 220A is placed on the respective examination hall, and then placed in the “Access Point” mode by the designated personnel in charge of the examination hall providing his credentials using a combination of multiple parameters including hardware authentication, user data validation, time-based validation and user biometrics including finger-prints, retina scan and face scan. The Local Hub 220A is placed in the “Access Point” mode, after authentication of the designated personnel and after verification that the designated personnel providing the credentials are one and the same.

The remote devices 260A-260E through a pre-determined network interface connect to the local hub 220A. In one embodiment, the pre-determined network interface could be a Near Field Communication connection established between the Local hub 220A and the set of remote devices 260A-260E.

On establishing connection using the pre-determined network interface, the local hub 220A provides the credentials to connect to it through a secured wireless network. The local hub 220A then receives the credentials from remote devices 260A-260E as the remote devices seek to connect. Upon authentication, the wireless connection between the local hub 220A and the remote devices 260A-260E is established and then the encrypted electronic document and the schedule is received at the local device (See steps 370 and 380 of FIG. 3B).

The users (for e.g., examinees) who take the examination are then authenticated. The users provide their credentials (for e.g. registration number, biometric credentials). The Local Hub 220A then verifies whether the user is the intended recipient of the electronic document. The encrypted electronic document is decrypted using decryption key at the scheduled time and displayed on the remote device. The electronic document is also displayed in the remote device only between the scheduled time and automatically stops displaying the electronic document after the scheduled time period. To ensure that the electronic document is displayed to the intended recipient, prior to the scheduled display of the document, based on the credentials of the recipient, the recipient is authenticated as the intended recipient.

To curtail possible malpractices, the remote devices sends a Bluetooth Low Energy “heartbeat” signal to the Local hub at regular intervals during the schedule, so as to indicate that the remote devices are in the range of the Local hub, On non-receipt of the “heartbeat” signal from the remote devices, appropriate action such as stopping the display of the secured document in the remote device, alarm to indicate movement of the device outside the designated area and automatically stop the display of the secured document is performed.

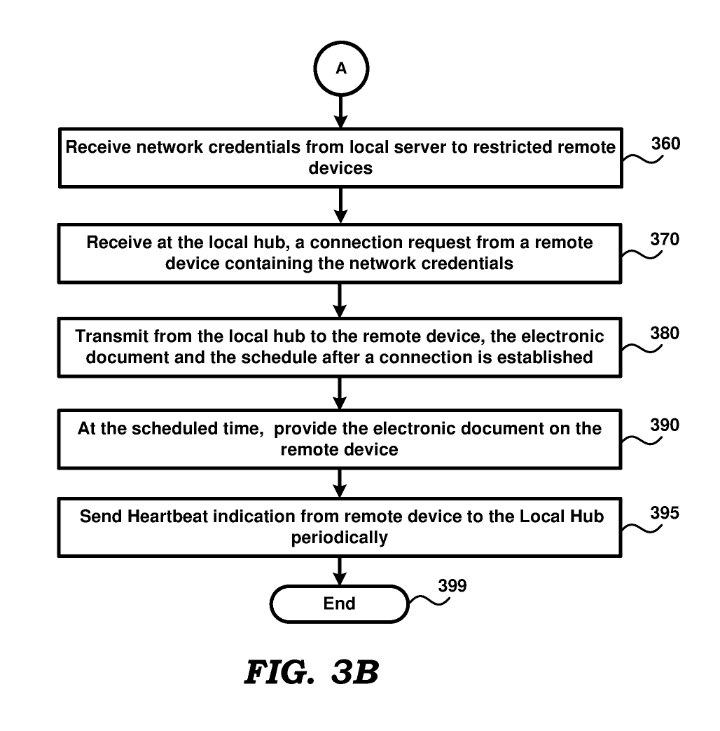

The manner in which the encrypted electronic document to the intended recipient in a secured manner is explained above. However, during the conducting of examinations different types of data are required to conduct and perform the delivery of the secured electronic document. The data and the manner in which the data interacts for conduct of examinations is explained with respect to FIG. 4 below.

### 6. Data for Conducting Examinations

FIG. 4 depicts portions of a scheduling data specifying the details of examination, students taking the examinations, schedule of examinations, locations of examinations and the details as to electronic document and the intended recipient data. For illustration, the scheduling data are assumed to be maintained in the form of tables in data store 120 or portions of the data are stored in each of the Local server 220, Local hubs and the remote devices. However, in alternative embodiments, the object data and mapping data may be maintained according to other data formats (such as files according to extensible markup language (XML), etc.) and/or using other data structures (such as lists, trees, etc.), as will be apparent to one skilled in the relevant arts by reading the disclosure herein.

Table 410 depicts master data specifying the detail of examination, schedule of examination, the location of the scheduled examination and the students who are poised to appear for the examination. Each of the rows of table 410 specifies the details of a corresponding examination scheduled in the near future.

In particular, column “Examination” indicates a corresponding Examination scheduled, column “Schedule” indicates the schedule of examination (a specific date range) for the corresponding Examination, column “Location” indicates the locations that the corresponding examination needs to be conducted and the column “Students” indicating the specific set of students who are poised to appear for the scheduled examination.

Table 420 depicts the session data specifying the details as to the sessions for a scheduled examination, the date and time of the scheduled examination, the locations (examination centers) where the examination is to be conducted, the specific set of students who will be appearing for the session, the examination and the question paper which needs to be provided to the students. Each of the rows of table 420 specifies the details of a session of a corresponding examination scheduled in the near future.

In particular, column “Session” indicates the session of the scheduled examination, the Date Time column providing details as to when a particular session of examination is scheduled, the column “location” providing details as to where the specific session of examination needs to be conducted, the column “Students” providing details as to the specific set of the students taking the examination, the column “Examination” providing details as to the scheduled examination and the column “Question paper” providing details as to the which question paper needs to be delivered to the specific set of students appearing for the examination.

Table 430 depicts the document data specifying the details as to the question paper that needs to be delivered. Each of the rows of table 430 specifies the details of the question paper

In particular, column “Question Paper” indicates the question paper that the student is appearing for, the column “Document ID” providing the details and path where the question paper might have been stored and the column “Decryption Key” providing details as to the decryption key that needs to be used to decrypt the question paper at the given time.

Table 440 depicts the student data specifying the details as to the individual students taking the examination. Each of the rows of table 420 specifies the details of the student appearing for the examinations.

In particular, column “Student Name” indicates the student who will be appearing for a given examination, the column “Session” provides details as to the sessions that he needs to appear in, and the column “Authentication Data” provides details as to the authentication that the student will provide to appear for the examination.

For the sake of convenience, assuming student S1111 has registered for examination E1 scheduled from 23 Nov. 2017 to 28 Nov. 2017, at location L1 for session S1. The question paper Q1 having the document ID:\\C\\E1\QP\subject1.pdf is accessed and decrypted and displayed in the remote device at 9 AM after providing the authentication by biometric means.

### 7. Copying Data to Multiple Devices

In the embodiment of the invention, additional devices such as server hub copier 510 may be used for facilitating the copying of electronic document and the data to multiple devices such that conducting examinations in multiple halls in a given examination center is facilitated.

FIG. 5A is a block diagram illustrating an specific embodiment of the delivery system 200, wherein a specialized device server-hub copier 510 is used to transfer the encrypted electronic document and the data for conducting the examination to one or more local hubs 220A and 220B. The specialized device server-hub copier 510 is explained further below.

FIG. 5B is a block diagram illustrating a server hub copier 510 that facilitates copying data between a given local server 210A and the local hubs 220A and 220B. A server-hub copier 510 is a hardware device that facilitates data transfer between a local server and multiple local hubs. The server-hub copier 510 contains a server slot 520 for a local server and one or more hub slots (530A, 530B, 530C and 530D) for local hubs. The server hub copier 510 is internally networked to transfer data between the local server and each of the local hubs. The server hub copier 510 also has means to charge the local hubs and transfer authentication data to be used for connecting each of the remote devices to the local hubs. The physical interfacing between the local hub and the local hubs may be performed through an RS-232 interface between the local server 210 and the local hubs 220A, 220B.

Authorized personnel in charge of delivery of the secured electronic document, the local server in the server slot and then places the local hubs in the hub slots. After providing the authentication data (biometric or a securely delivered pass code), the authorized personnel initiates the transfer of the encrypted electronic data from the local server to the local hubs. While removing the local hubs from the server-hub copier, the designated personnel provides his authentication data (biometric or a securely delivered pass code) to remove the local hubs.

FIG. 5C is a block diagram illustrating a Hub-Device carrier 550 that facilitates carrying the local hub 210A and the one or more remote devices 260A-260E. The hub device copier carrier a hub slot (560) for a local hub and one or more device slots (570A-570D) for carrying the local hub and the one or more remote devices and has means to charge the remote devices and transfer authentication data for connecting each of the remote devices to the local hub.

Thus, the server-hub copier copies the encrypted electronic document without requiring additional network infrastructure and ensures timely delivery of the electronic documents to even in remote geographical locations.

It should be appreciated that the features described above can be implemented in various embodiments as a desired combination of one or more of hardware, software, and firmware. The description is continued with respect to an embodiment in which various features are operative when the software instructions described above are executed.

### 8. Digital Processing System

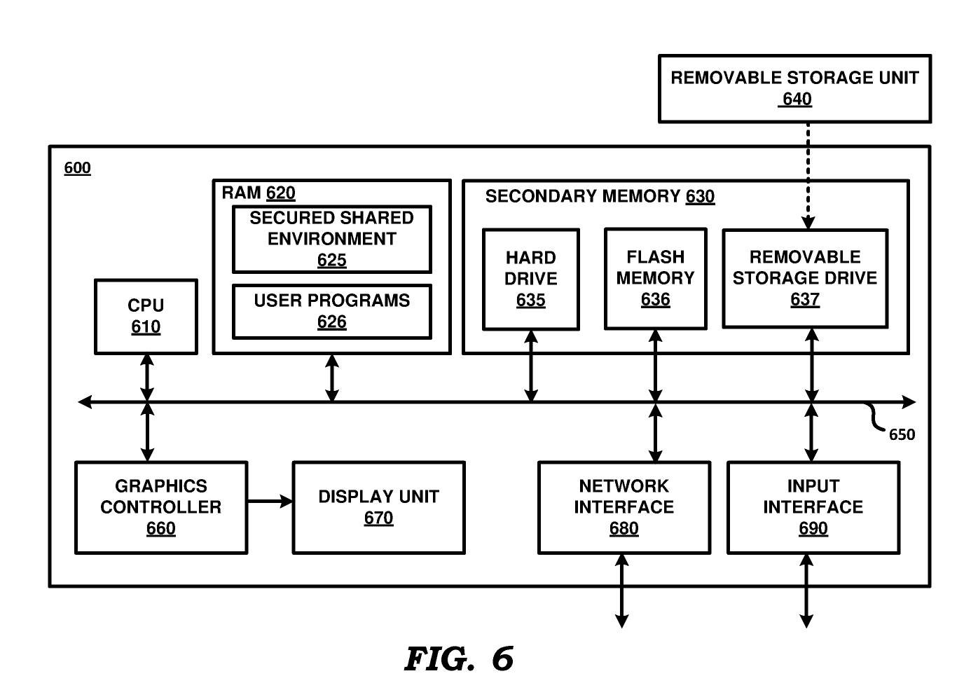

FIG. 6 is a block diagram illustrating the details of digital processing system 600 in which various aspects of the present disclosure are operative by execution of appropriate executable modules. Digital processing system 600 may correspond to each of Administration Server 130, Client System 140, Local Server 210, Local Hubs 220A, 220B.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail. In a preferred embodiment, the access to the network interface 680 and the input interface may be restricted and would be in the form of specialized ports/interfaces that are operable only with the specific device.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and/or other user programs 626 (such as other applications, DBMS, etc.). In addition to shared environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (of FIG. 1) connected to the network (110).

Secondary memory 630 may contain hard drive 635, flash memory 636, and removable storage drive 637. Secondary memory 630 may store the data (for example, data of FIG. 3, the group of values identified for each dimension, etc.) and software instructions (for example, for implementing the flowchart of FIGS. 3A and 3B, computing the values of the dimensions, etc.), which enable digital processing system 600 to provide several features in accordance with the present disclosure. The code/instructions stored in secondary memory 630 may either be copied to RAM 620 prior to execution by CPU 610 for higher execution speeds or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A delivery system operable in conjunction with an administration system for delivering electronic documents, the delivery system comprising:
a plurality of remote devices, each for use by a corresponding intended recipient;
a local server to receive an electronic document from the administration system on a secure channel ahead of a required delivery time; and
a local hub to receive the electronic document from the local server ahead of the required delivery time,
wherein each of said plurality of remote devices interfaces with said local hub to authenticate a corresponding intended recipient and to receive the electronic document upon successful authentication,
wherein the local server, the local hub and each remote device operate in conjunction to ensure that the content of the electronic document is available to the corresponding recipient only at the required delivery time.

2. The delivery system of claim 1, wherein the administration system performs encryption of the electronic document to generate an encrypted document, wherein the local server and local hub receive and forward the encrypted document to the plurality of remote devices,
wherein each remote device is operable to perform decryption of the encrypted document just prior to the required delivery time to facilitate the content of the electronic document to be made available to the corresponding recipient.

3. The delivery system of claim 2, wherein the encryption and decryption is performed using a 128-bit key.

4. The delivery system of claim 1, wherein the local server also receives from the administration system, a session data indicating the required delivery time of the electronic document and the authentication details of the intended recipients,
wherein the local hub receives the session data from the local server and performs authentication of the corresponding intended recipients based on the session data.

5. The delivery system of claim 4, wherein the authentication comprises device-based authentication of the remote device and user-based authentication of the intended recipient.

6. The delivery system of claim 5, wherein the user-based authentication is performed using a combination of multiple parameters including hardware authentication, user data validation, time based validation and user biometrics including finger-prints, retina scan and face scan.

7. The delivery system of claim 4, wherein the local server receives the electronic document and the session data over the secure channel, stores a local copy of the electronic document and the session data in a secured storage and provides the local copy of the electronic document and the session data to the local hub,
wherein the combination of the local server, local hub and the plurality of remote devices is facilitated to be isolated from the administration system after receipt of the electronic document and the session data.

8. The delivery system of claim 4, further comprising a server-hub copier that copies the electronic document and the session data from the local server to the local hub via a first physical interface.

9. The delivery system of claim 8, wherein the first physical interface is implemented using RS-232 protocol.

10. The delivery system of claim 1, wherein the local hub generates network credentials for establishing a local network, the local hub and one or more remote devices establishes a connection over a pre-defined network interface and the local hub sends the network credentials to one or more remote devices,
wherein a remote device establishes a connection over the local network with the local hub using the network credentials and receives the electronic document and the session data over the connection upon successful authentication.

11. The delivery system of claim 10, wherein the pre-defined network interface is a short-range wireless data exchange protocol such as Near Field Communication (NFC) protocol or Bluetooth protocol.

12. The delivery system of claim 11, wherein the local hub and the one or more remote devices are tightly coupled with each other based on hardware tags.

13. A method of delivering electronic documents from an administration system to a plurality of remote devices, each remote device for use by a corresponding intended recipient, the method comprising:
receiving, at a local server, an encrypted electronic document from the administration system on a secured channel ahead of a required delivery time;
transferring to a local hub from the local server the encrypted electronic document ahead of the required delivery time;
authenticating at the local hub, a first instance, the intended recipient for the delivery of the said encrypted electronic document;
at the scheduled time, delivering for display the electronic document to the intended recipient.

14. The method of claim 13, wherein the receiving the electronic document by the local server comprises of:
downloading and storing the electronic document in a secured non-volatile storage after authentication of the local server by the administration system.

15. The method of claim 13, wherein the transfer of the encrypted electronic document from the local server to one or more local hubs via the physical interface after determining that the local server and one or more local hubs are connected.

16. The method of claim 13, wherein the transfer of the electronic document from the local server to one or more local hubs is initiated when the local hubs are put in data-copy mode.

17. The method of claim 13, wherein the interfacing of the one or more remote devices with the local hub comprises of:
establishing a local network with the one or more connected remote devices with the local hub by performing the steps of:
pairing the one or more remote devices with the local hub;
copying the credentials from the local hub to the one or more remote devices;
receive a connection request from the one or more remote devices to the local hubs using the copied credentials;
accept the connection request from the one or more remote devices by the local hub.

18. The method of claim 17, wherein pairing the one or more remote devices with the local hub is performed based on short-range wireless data exchange protocol such as Near Field Communication (NFC) protocol or Bluetooth protocol,
wherein the one or more remote devices and the local hub are tightly coupled with each other based on hardware tags.

19. The method of claim 13, wherein the delivering for display the electronic documents to the one or more remote devices, comprises the steps of:
the local hub authenticating the corresponding intended recipient of the encrypted electronic document; and
the local server, the local hub and each remote device operate in conjunction to ensure that the content of the electronic document is available to the corresponding recipient only at the required delivery time.

20. The method of claim 19, wherein the authenticating the corresponding intended recipient comprises device-based authentication of remote device and user-based authentication of the intended recipient.
